(19) United States
(12) Patent Application Publication
(10) Pub. No.: US 2006/0136471 A1
(43) Pub. Date: Jun. 22, 2006

(54) Differential management of database schema changes

(75) Inventors: Kang Ge, Markham (CA); Miu-to Brenda Lam, North York (CA); Wan Ngai Wayne Lee, North York (CA)

Correspondence Address: INTERNATIONAL BUSINESS MACHINES CORP;IP LAW, 555 BAILEY AVENUE , J46/G4, SAN JOSE, CA, 95141, US

(73) Assignee: International Business Machines Corporation

(21) Appl. No.: 11/016,228

(22) Filed: Dec. 17, 2004

(51) Int. Cl. G06F 17/00

(52) U.S. Cl. 707/102

(57) ABSTRACT

A data processing system-implemented method, system and article of manufacture for differential schema migration. A differential schema migration system can include a schema extractor configured both to extract a contemporary schema and corresponding contemporary data from a first connected database and also to generate an intermediately formatted form of the contemporary schema and corresponding contemporary data. The system also can include a schema update user interface configured to facilitate applying changes to the intermediately formatted form of the contemporary schema and corresponding contemporary data. Finally, the system can include a schema differential migrator configured to apply changes to a second connected database based upon a comparison of an extracted schema and corresponding data from the second connected database, and a changed version of the intermediately formatted form of the contemporary schema and corresponding contemporary data.

### BACKGROUND OF THE INVENTION

1. Statement of the Technical Field

The present invention relates to the field of database management systems and more particularly to management of schema changes in a database management system.

2. Description of the Related Art

In the study and practice of computer science, a database schema is the organization or structure for a database. Typically, the activity of data modeling leads to a database schema which derives from the Greek term for “form” or “figure.” The term “schema” often has been used in discussing both relational databases and object-oriented databases. Moreover, the term “schema” sometimes seems to refer to a visualization of a structure and sometimes to a formal text-oriented description. In the relational database arts, the schema defines the tables, the fields in each table, and the relationships between fields and tables. In this regard, schemas are generally stored in a data dictionary. Although a schema is defined in text database language, the term is often used to refer to a graphical depiction of the database structure.

A database generally remains operable for as long as the data stored within the database remains important and for as long as access will be required to the data. Yet, given the extended lifetime of a database, the underlying database schema often will change in response to new computing and real-world demands associated with the data. Accordingly, when a schema changes to support changes in the computing environment and real-world purpose, the implementation of the physical storage of the data also can change. Moreover, the interface to the data further can change along with changes to the schema. Thus, “schema evolution” can have a wide ranging impact on a data driven computing system.

Schema evolution often involves the addition or removal of one or more fields in a table. Small scale schema changes limited to the addition or removal of a few fields can be manageable in the context of a small, data driven computing system. As schema changes become more extensive, however, to accommodate far-reaching changes in the purpose or functionality of the data driven computing system several technologies have been developed to facilitate schema evolution. Several methodologies are described in Barbara Stuadt Lerner, A Model for Compound Type Changes Encountered in Schema Evolution, in ACM Transactions on Database Systems, Vol. 25, No. 1 at 83-127 (March 2000). Notwithstanding, all such methodologies presume the ability to deploy a schema update in a single process across the entirety of the enterprise.

Notwithstanding the foregoing, in a diverse enterprise computing environment having a large-scale, relational database driven application deployed across multiple, infrastructures, the task of maintaining schema consistency despite schema evolution can be monumental. Typically, the database driven application can be developed independently from the production environment. As such, new features involving schema changes are deployed to the production environment only incrementally during the course of several deployment phases. For each deployment phase, some schema migration may be required. Yet, performing incremental schema migration in the traditional manner utilizing scripts can be characterized as error-prone resulting in many problems remaining undetected until substantial damage has occurred.

### SUMMARY OF THE INVENTION

The present invention addresses the deficiencies of the art in respect to schema evolution and database migration and provides a novel and non-obvious data processing system-implemented method, system and article of manufacture for the differential migration of a database schema. In this regard, a differential schema migration system can include a schema extractor configured both to extract a contemporary schema and corresponding contemporary data from a first connected database and also to generate an intermediately formatted form of the contemporary schema and corresponding contemporary data. The system also can include a schema update user interface configured to facilitate applying changes to the intermediately formatted form of the contemporary schema and corresponding contemporary data.

Importantly, the system can include a schema differential migrator configured to apply changes to a second connected database based upon a comparison of an extracted schema and corresponding data from the second connected database, and a changed version of the intermediately formatted form of the contemporary schema and corresponding contemporary data. Preferably, the intermediately formatted form can include an extensible markup language (XML) compliant markup language document. Moreover, the intermediately formatted form can include a separate file for each of the contemporary schema and the corresponding contemporary data. Notably, the second connected database can be the first connected database. Finally, the schema can include meta-data selected from the group consisting of at least one specified table, at least one index, at least one constraint, and at least one trigger definition.

A data processing system-implemented method for differential schema migration can include comparing an intermediately formatted schema and corresponding data to a contemporary schema and corresponding contemporary data in a database. The comparison can determine differences between both the intermediately formatted schema and the contemporary schema in the database, and also the intermediately formatted corresponding data and the contemporary data in the database. Subsequently, the differences can be applied to the database. Preferably, the comparing step can include first connecting to a first database and first extracting a contemporary schema and corresponding contemporary data from the first connected database. Consequently, an intermediately formatted contemporary schema and corresponding contemporary data can be generated.

Changes to the intermediately formatted contemporary schema and corresponding contemporary data can be applied subsequent to which a second connection can be established to a second database. Thereafter, a contemporary schema and corresponding contemporary data can be extracted from the second connected database. Finally, the changed intermediately formatted schema and corresponding data can be compared to the extracted contemporary schema and corresponding contemporary data from the second database. Differences between both the intermediately formatted schema and the contemporary schema from the second connected database can be determined, as can the intermediately formatted corresponding data and the contemporary data from the second connected database. It is these differences that can be applied to the second connected database.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a data processing system for differential migration of a database schema; and,

FIG. 2 is a flow chart illustrating a process for differentially migrating a database schema.

### DETAILED DESCRIPTION OF THE PREFERRED EMBODIMENTS

The present invention is a data processing system-implemented method, system and article of manufacture for the differential migration of a database schema. In accordance with the present invention, the process of migrating a database to accommodate a new schema can be trifurcated into an extraction process, an update process, and a differential migration process. In the extraction process, the contemporary state of the database can be extracted from the database, including both schema and data into an intermediate form. In the update process, the intermediate form can be updated to include the changes to the schema and any changes to the data. Finally, in the differential migration process, the changes to the intermediate form can be compared to the contemporary state of the database and the differences can be applied to the database. In this way, the error-prone process of migration scripts can be avoided as the contemporary state and its differences from the updated state can be known at the time of migration.

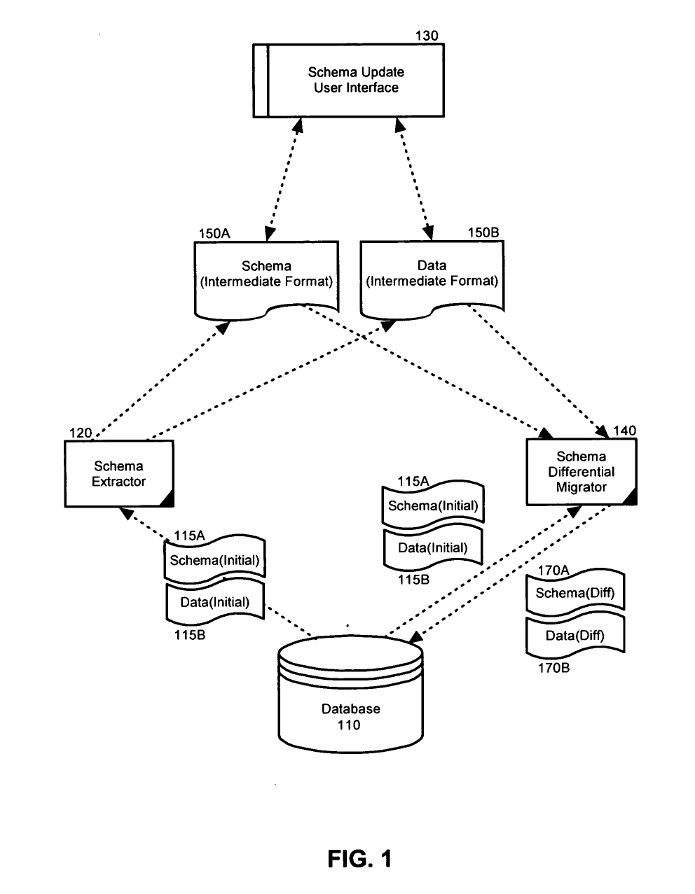

In more particular illustration of the present invention, FIG. 1 is a block diagram illustrating a system, method and article of manufacture for differential migration of a database schema. As shown in FIG. 1, the data processing system of the present invention can include each of a schema extractor 120, a schema update user interface 130 and a schema differential migrator 140. The schema extractor 120 can be communicatively linked to a database 110 from which both a contemporary form of the database schema 115A and the data 115B within the database 110 can be extracted. The extractor 120 further can be configured to produce each of an intermediately formatted schema 150A and intermediately formatted data 150B. In a preferred albeit non-exclusive aspect of the invention, the intermediate format can be a format which comports with the XML specification.

The schema update user interface 130 can be configured to read the intermediately formatted schema 150A and the intermediately formatted data 150B. Subsequently, the schema update user interface 130 can render a user interface, such as a visual user interface, through which an end user can review the content of the intermediately formatted schema 150A and the intermediately formatted data 150B. At the discretion of the end user, modifications, additions and deletions to the intermediately formatted schema 150A and the intermediately formatted data 150B can be applied thereto and saved so as to overwrite the intermediately formatted schema 150A and the intermediately formatted data 150B.

Finally, the schema differential migrator 140 can retrieve a contemporary form of the database schema 115A and the data 115B within the database 110. Additionally, the differential migrator 140 can retrieve the intermediately formatted schema 150A and the intermediately formatted data 150B. The differential migrator 140 subsequently can compare the contemporary form of the database schema 115A to the intermediately formatted schema 150A to identify changes in the contemporary form of the database schema 115A. Similarly, the differential migrator 140 can compare the contemporary form of the data 115B to the intermediately formatted data 150B to identify changes in the contemporary form of the data 115B. Finally, the identified changes to the schema 170A and the identified changes to the data 170B can be applied to the database 110.

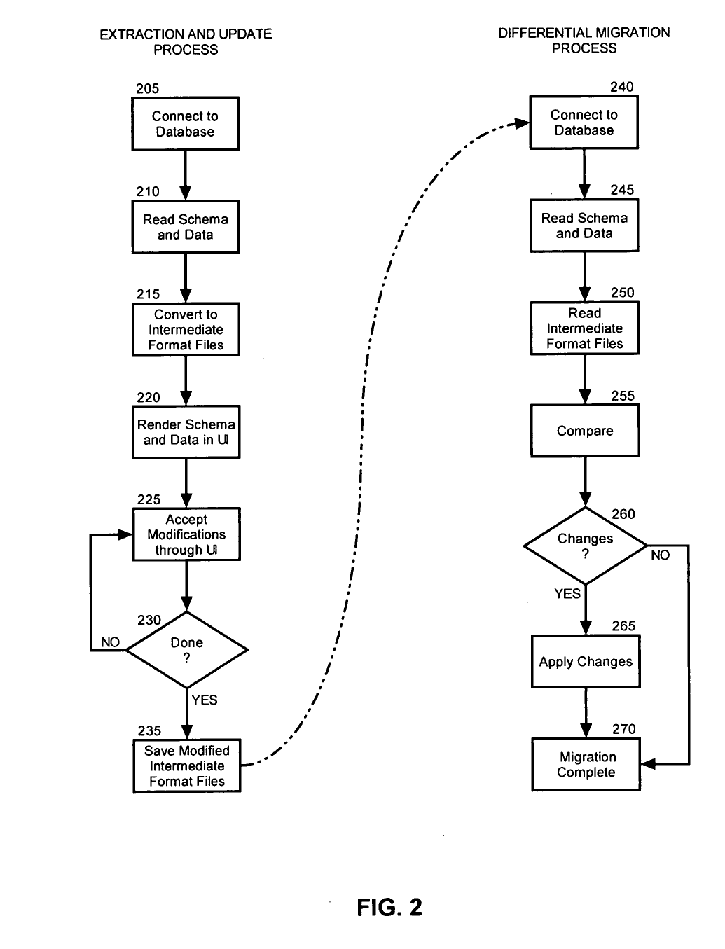

FIG. 2 is a flow chart illustrating a process for differentially migrating a database schema. The process can be trifurcated into extraction, update and differential migration sub-processes. First, beginning in block 205 in an extraction sub-process a connection can be established to a database, for instance via a database connectivity call. Subsequently, in block 210 the contemporary schema information, including table structure, index, constraint and trigger definitions, can be read from the database. Also, in block 210 the contemporary data in the tables of the database can be read from the database. Finally, in block 215, the schema information and data can be written to an intermediately formatted file or files, for instance an XML formatted file, or perhaps in another markup language format, in a text format, a binary format, or in an additional database format.

Beginning in block 220 in an update sub-process the intermediately formatted schema and data can be processed and rendered either partially or wholly within a user interface. Utilizing the user interface, end users can applied desired modifications, additions and deletions to the schema, data or both. In this regard, in block 225, the desired modifications, additions and deletions to either or both of the schema and data can be accepted through the user interface. If in decision block 230 the end user has completed the updating sub-process, in block 235 the modifications to either or both of the schema and data can be persisted in the intermediately formatted file or files. In particular, the intermediate form of the schema can be stored apart from the data, or both can be stored in the same intermediately formatted file.

Beginning in block 240 in a differential migration process a connection can be established to a database. Notably, though it is anticipated that the database will be the same database as before in the extraction sub-process, the invention is not so limited and any other database can be targeted for differential schema migration in accordance with the present invention. In any event, in block 245 the contemporary schema and data of the connected database can be retrieved. Also, in block 250 the intermediately formatted schema and data can be retrieved. In block 255, the intermediately formatted schema can be compared to the contemporary schema of the connected database. Similarly, the intermediately formatted data can be compared to the contemporary data of the connected database.

In decision block 260, if a change to the schema, data or both has been detected, in block 265 the changes can be applied to the connected database. Finally, in block 270 the differential migration sub-process will be complete. Importantly, because only the schema and data changes are applied to the connected database, substantial resource consumption efficiencies can be realized in consequence of the present invention. Moreover, as the changes are measured as between the intermediately formatted information and a contemporary form of the database, the differential migration process can accommodate incremental schema change rollouts in a diverse enterprise computing environment having a large-scale, relational database driven application deployed across multiple, infrastructures.

It will be recognized by the skilled artisan that by representing a database schema in a structured format which is easily extensible the schema migrator component can establish a framework for pluggable modification handlers according to defined database rules and application handlers to support application rules. For instance, the rules can be categorized into two types: one that follows database rules and the other follows application rules. However, the invention can be generalized to support other categories if the rules can be represented in the defined structure.

The database rules can apply to the creation, alteration, or deletion of a schema, table, primary key, index, foreign key, view, alias, trigger and function to name a few. In this regard, special modification handlers can be implemented as follows:
1. For deleting a schema, it can be specified that to delete a schema, all tables, aliases, views, indexes, triggers and functions first must be deleted before deleting the schema.
2. For changing the tablespace for a table, it can be specified that if the tablespace, index tablespace or long column tablespace are changed for a table, the data is to be saved, the table is to be dropped, and the table is to be created in the new tablespace and the data is to be reloaded.
3. For adding a non-nullable column to a table, it can be specified that the data is to be saved, the table is to be dropped, the table is to be created in the new tablespace and the data is to be reloaded.
4. For altering a column, it can be specified that unless the alteration is supported by the alter table statement, the column size can be changed, the data can be saved, the table can be dropped, the table can be created in the new tablespace, and the data can be reloaded.

The application rules, by comparison can be specified as an example to support an “Under Construction” function. To support the under construction function, tables, aliases, triggers and views can be created based upon an “under construction” schema. Specifically, tables can be created for a selection of core tables and their descendants. Aliases can be created in the under construction schema for any other tables. Deletion triggers, insertion triggers, and update triggers can be created for selected ones of the created tables. Deletion triggers, insertion triggers, and update triggers further can be created for selected second level tables. Subsequently, certain specified special rules and handling can be applied. Finally, views in the under construction schema can be created.

The application rules also can specify, for example, the creation of a data propagation script for tables to be propagated. To support data propagation between production and staging databases, specified tables can be enabled for propagation. Specifically, for a table marked for propagation and defined in a new subscription, a subscription set and a changed data table can be created and the table can be registered to a data propagation module. For a table marked for propagation and defined in an existing subscription, the changed data table can be created and registered to the data propagation module. Finally, for a table already marked for propagation, where the table definition has been changed, the changed data table can be dropped and recreated.

The application rules yet further can specify the creation of complete set of aliases for a schema. Specifically, the rule can state that for every table in the schema, a complete set of aliases is to be created for a different schema.

The present invention can be realized in hardware, software, or a combination of hardware and software. An implementation of the data processing system-implemented method and system of the present invention can be realized in a centralized fashion in one computer system or in a distributed fashion where different elements are spread across several interconnected computer systems. Any kind of computer system, or other apparatus adapted for carrying out the methods described herein, is suited to perform the functions described herein.

A typical combination of hardware and software could be a general purpose data processing system with a computer program that, when being loaded and executed, controls the data processing system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A data processing system for differential schema migration, the data processing system comprising:
a schema extractor configured both to extract a contemporary schema and corresponding contemporary data from a first connected database and also to generate an intermediately formatted form of said contemporary schema and corresponding contemporary data;
a schema update user interface configured to facilitate applying changes to said intermediately formatted form of said contemporary schema and corresponding contemporary data; and,
a schema differential migrator configured to apply changes to a second connected database based upon a comparison of an extracted schema and corresponding data from said second connected database, and a changed version of said intermediately formatted form of said contemporary schema and corresponding contemporary data.

2. The data processing system of claim 1, wherein said intermediately formatted form comprises an XML compliant markup language document.

3. The data processing system of claim 1, wherein said intermediately formatted form comprises a separate file for each of said contemporary schema and said corresponding contemporary data.

4. The data processing system of claim 1, wherein said second connected database is said first connected database.

5. The data processing system of claim 1, wherein said schema comprises meta-data selected from the group consisting of at least one specified table, at least one index, at least one constraint, and at least one trigger definition.

6. The data processing system of claim 1, wherein said schema differential migrator further comprises at least one pluggable modification handler.

7. A data processing system implemented method for performing differential schema migration, the data processing system implemented method comprising:
comparing an intermediately formatted schema and corresponding data to a contemporary schema and corresponding contemporary data in a database to determine differences between both said intermediately formatted schema and said contemporary schema in said database, and also said intermediately formatted corresponding data and said contemporary data in said database; and,
applying said differences to said database.

8. The data processing system implemented method of claim 7, wherein said comparing step comprises:
first connecting to a first database;
first extracting a contemporary schema and corresponding contemporary data from said first connected database;
generating an intermediately formatted contemporary schema and corresponding contemporary data;
applying changes to said intermediately formatted contemporary schema and corresponding contemporary data;
second connecting to a second database;
second extracting a contemporary schema and corresponding contemporary data from said second connected database; and,
comparing said changed intermediately formatted schema and corresponding data to said extracted contemporary schema and corresponding contemporary data from said second database to determine differences between both said intermediately formatted schema and said contemporary schema from said second connected database, and also said intermediately formatted corresponding data and said contemporary data from said second connected database.

9. The data processing system implemented method of claim 8, wherein said step of first extracting a contemporary schema comprises the step of first extracting meta-data selected from the group consisting of at least one specified table, at least one index, at least one constraint, and at least one trigger definition.

10. The data processing system implemented method of claim 9, wherein said step of second extracting a contemporary schema comprises the step of second extracting meta-data selected from the group consisting of at least one specified table, at least one index, at least one constraint, and at least one trigger definition.

11. The data processing system implemented method of claim 8, wherein said generating step comprises the step of generating an XML compliant markup language document containing said contemporary schema and corresponding contemporary data.

12. The data processing system implemented method of claim 8, wherein said generating step comprises the step of generating an intermediately formatted contemporary schema and separate intermediately formatted corresponding contemporary data.

13. The data processing system implemented method of claim 8, wherein said second connecting step comprises the step of second connecting to said first connected database.

14. An article of manufacture for directing a data processing system to perform differential schema migration, the article of manufacture comprising:
a computer usable medium embodying one or more instructions executable by the data processing system, the one or more instructions comprising:
data processing system executable instructions for comparing an intermediately formatted schema and corresponding data to a contemporary schema and corresponding contemporary data in a database to determine differences between both said intermediately formatted schema and said contemporary schema in said database, and also said intermediately formatted corresponding data and said contemporary data in said database; and,
data processing system executable instructions for applying said differences to said database.

15. The article of manufacture of claim 14, wherein said comparing step comprises:
data processing system executable instructions for first connecting to a first database;
data processing system executable instructions for first extracting a contemporary schema and corresponding contemporary data from said first connected database;
data processing system executable instructions for generating an intermediately formatted contemporary schema and corresponding contemporary data;
data processing system executable instructions for applying changes to said intermediately formatted contemporary schema and corresponding contemporary data;
data processing system executable instructions for second connecting to a second database;
data processing system executable instructions for second extracting a contemporary schema and corresponding contemporary data from said second connected database; and,
data processing system executable instructions for comparing said changed intermediately formatted schema and corresponding data to said extracted contemporary schema and corresponding contemporary data from said second database to determine differences between both said intermediately formatted schema and said contemporary schema from said second connected database, and also said intermediately formatted corresponding data and said contemporary data from said second connected database.

16. The article of manufacture of claim 15, wherein said step of first extracting a contemporary schema comprises:
data processing system executable instructions for first extracting meta-data selected from the group consisting of at least one specified table, at least one index, at least one constraint, and at least one trigger definition.

17. The article of manufacture of claim 16, wherein said step of second extracting a contemporary schema comprises:
data processing system executable instructions for second extracting meta-data selected from the group consisting of at least one specified table, at least one index, at least one constraint, and at least one trigger definition.

18. The article of manufacture of claim 15, wherein said generating step comprises:
data processing system executable instructions for generating an XML compliant markup language document containing said contemporary schema and corresponding contemporary data.

19. The article of manufacture of claim 15, wherein said generating step comprises:
data processing system executable instructions for generating an intermediately formatted contemporary schema and separate intermediately formatted corresponding contemporary data.

20. The article of manufacture of claim 15, wherein said second connecting step comprises:
data processing system executable instructions for second connecting to said first connected database.
